(19) United States
(12) Patent Application Publication
(10) Pub. No.: US 2024/0312429 A1
(43) Pub. Date: Sep. 19, 2024

(54) DISPLAY DEVICE AND SOURCE DRIVER

(71) Applicant: LAPIS Technology Co., Ltd., Yokohama (JP)

(72) Inventor: Hiroaki ISHII, Yokohama (JP)

(73) Assignee: LAPIS Technology Co., Ltd., Yokohama (JP)

(21) Appl. No.: 18/603,166

(22) Filed: Mar. 12, 2024

(30) Foreign Application Priority Data
Mar. 14, 2023 (JP) 2023-039704

(51) Int. Cl. G09G 3/36; G09G 3/00

(52) U.S. Cl. CPC G09G 3/3688; G09G 3/006; G09G 2320/041; G09G 2320/0673; G09G 2330/12

(57) ABSTRACT

A display device includes: a display panel, including a first substrate having a display area, display wiring including a plurality of source lines and a plurality of gate lines formed in the display area, and first wiring formed in an area outside the display area of the first substrate; and a source driver, provided outside the first substrate, including a temperature calculator that calculates a temperature of the first substrate based on a potential difference between one end and the other end of the first wiring, the source driver driving the plurality of source lines.

### CROSS-REFERENCE TO RELATED APPLICATIONS

This application claims the priority benefit of Japan Application No. 2023-039704, filed on Mar. 14, 2023. The entirety of the above-mentioned patent application is hereby incorporated by reference herein and made a part of this specification.

### BACKGROUND

### Technical Field

The disclosure relates to a display device and a source driver.

### Related Art

In a liquid crystal display device, a gamma correction curve of liquid crystal is adjusted according to an ambient temperature of a liquid crystal panel. A display device has been proposed in which, to perform gamma correction in accordance with the ambient temperature of the liquid crystal panel, a temperature sensor is provided connected to a gamma correction circuit and the gamma correction is performed according to a detected temperature (for example, Japanese Patent Laid-Open No. 2005-266154).

In order to automatically perform the gamma correction according to the temperature, the temperature sensor is necessary, thus increasing the number of parts of the liquid crystal panel. In a configuration in which a temperature sensor is built in a source driver or the configuration in which the temperature sensor is provided outside the gamma correction circuit as in the above conventional technology, since the temperature sensor is arranged in a position away from a display surface of the liquid crystal panel, it is difficult to accurately perform temperature correction.

### SUMMARY

A display device according to the disclosure includes: a display panel, including a first substrate having a display area, display wiring including a plurality of source lines and a plurality of gate lines formed in the display area, and first wiring formed in an area outside the display area of the first substrate; and a source driver, provided outside the first substrate, including a temperature calculator that calculates a temperature of the first substrate based on a potential difference between one end and the other end of the first wiring, the source driver driving the plurality of source lines.

A source driver according to the disclosure is removably connected to a display panel that includes a first substrate, a plurality of source lines and first wiring. The first substrate has a display area. The plurality of source lines are formed in the display area. The first wiring is formed in an area outside the display area of the first substrate. The source driver drives the plurality of source lines. The source driver includes: a first terminal, connected to one end of the first wiring; a second terminal, connected to the other end of the first wiring; and a temperature calculator, calculating a temperature of the first substrate based on a potential difference between the one end and the other end of the first wiring.

### BRIEF DESCRIPTION OF THE DRAWINGS

FIG. 1 is a block diagram illustrating a configuration of a liquid crystal display device according to Example 1 of the disclosure.

FIG. 2 is a block diagram illustrating a schematic configuration of a display panel, a source driver, and dummy wiring for disconnection detection of Example 1.

FIG. 3 is a block diagram illustrating an internal configuration of the source driver of Example 1.

FIG. 4 is a block diagram illustrating a schematic configuration of a display panel, a source driver, and dummy wiring for disconnection detection of Example 2.

FIG. 5 is a block diagram illustrating an internal configuration of the source driver of Example 2.

FIG. 6 is a block diagram illustrating a schematic configuration of a display panel, a source driver, and MUX wiring of Example 3.

FIG. 7 is a block diagram illustrating an internal configuration of the source driver of Example 3.

FIG. 8 is a time chart illustrating a signal change in an enable control signal in Example 3.

### DESCRIPTION OF THE EMBODIMENTS

The disclosure provides a display device in which gamma correction according to temperature can be accurately performed without increasing the number of parts of a liquid crystal panel.

According to the display device according to the disclosure, the gamma correction according to the temperature can be accurately performed without increasing the number of parts of the liquid crystal panel.

Hereinafter, examples of the disclosure will be described with reference to the drawings. In the following description and accompany drawings regarding each example, substantially the same or equivalent portions are assigned the same reference numerals.

### Example 1

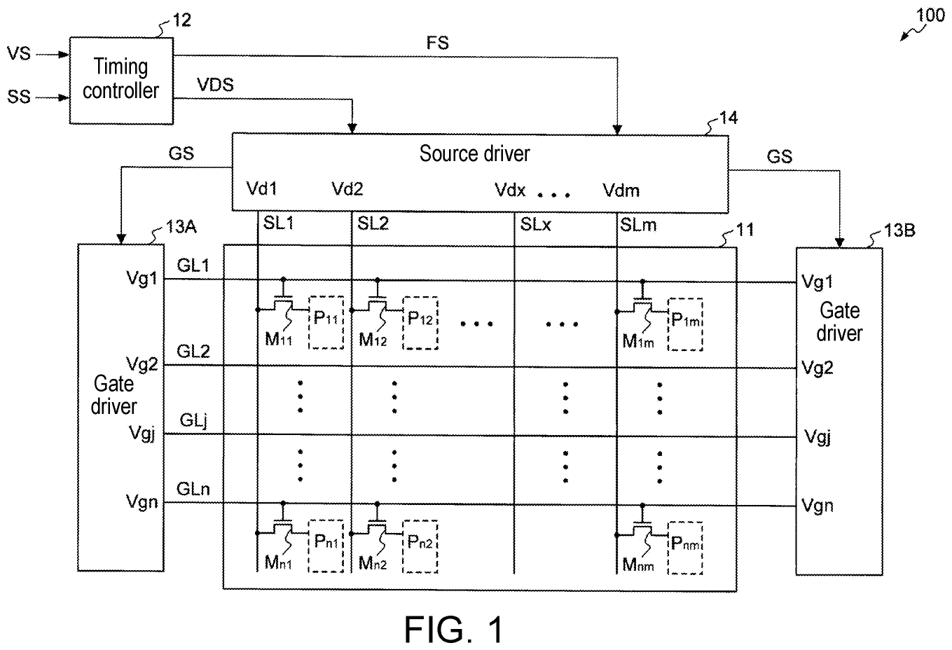

FIG. 1 is a block diagram of a display device 100 according to Example 1 of the disclosure. The display device 100 is an active matrix drive type liquid crystal display device. The display device 100 includes a display panel 11, a timing controller 12, gate drivers 13A and 13B, and a source driver 14.

The display panel 11 is composed of a first substrate which is a semiconductor substrate on which a plurality of pixel portions P₁₁ to Pₙₘ and a plurality of pixel switches M₁₁ to Mₙₘ (n, m: natural numbers of 2 or more) are arranged in a matrix. In the present example, the first substrate is a glass substrate.

The display panel 11 includes n gate lines GL1 to GLn each of which is a scanning line extending in a horizontal direction, and m source lines SL1 to SLm which are data lines arranged to intersect the gate lines GL1 to GLn. The pixel portions P₁₁ to Pₙₘ and the pixel switches M₁₁ to Mₙₘ are provided at intersections of the gate lines GL1 to GLn and the source lines SL1 to SLm.

The pixels switches M₁₁ to Mₙₘ are controlled to be turned on or off according to gate signals Vg1 to Vgn supplied from the gate drivers 13A and 13B.

The pixel portions P₁₁ to Pₙₘ are supplied with a gradation voltage (drive voltage) corresponding to video data from the source driver 14. Specifically, gradation voltage signals Vd1 to Vdm are output from the source driver 14 to the source lines SL1 to SLm, and when the pixel switches M₁₁ to Mₙₘ are respectively turned on, the gradation voltage signals Vd1 to Vdm are applied to the pixel portions P₁₁ to Pₙₘ. Accordingly, a pixel electrode of each of the pixel portions P₁₁ to Pₙₘ is charged, and luminance is controlled.

Each of the pixel portions P₁₁ to Pₙₘ includes a transparent electrode connected to the source lines SL1 to SLm via the pixel switches M₁₁ to Mₙₘ, and liquid crystal sealed between a semiconductor substrate and a counter substrate, the counter substrate being provided facing the semiconductor substrate and having one transparent electrode formed over the entire surface. With respect to a backlight inside the display device, display is performed by changing the transmittance of the liquid crystal according to a potential difference between a gradation voltage (drive voltage) applied to the pixel portions P₁₁ to Pₙₘ and a counter substrate voltage.

Based on video data VS, the timing controller 12 generates a sequence (serial signal) of pixel data pieces PD representing a luminance level of each pixel using, for example, 256 levels of luminance gradation of 8 bits. Based on a synchronization signal SS, the timing controller 12 generates an embedded clock type clock signal CLK having a constant clock period. The timing controller 12 generates a video data signal VDS which is a serial signal in which the sequence of pixel data pieces PD and the clock signal CLK are integrated, supplies the video data signal VDS to the source driver 14 and controls the display of video data. The video data signal VDS is configured as a video data signal serialized according to the number of transmission paths for each predetermined number of source lines.

In the present example, the video data signal VDS corresponding to one frame is configured by serially continuing n pixel data piece groups each including m pixel data pieces PD. Each of the n pixel data piece groups is a pixel data piece group including pixel data pieces corresponding to a gradation voltage to be supplied to the pixels on one horizontal scanning line (that is, each of the gate lines GL1 to GLn). By an operation of the source driver 14, based on m×n pixel data pieces PD, the gradation voltage signals Vd1 to Vdm to be supplied to n×m pixel portions (that is, pixel portions P₁₁ to Pₙₘ) are applied via a source line.

Based on the synchronization signal SS, the timing controller 12 generates a frame synchronization signal FS indicating a timing of each frame of the video data signal VDS and supplies the same to the source driver 14.

The gate drivers 13A and 13B are mounted on a glass substrate constituting the display panel 11 using gate in panel (GIP) technology. The gate drivers 13A and 13B are supplied with a gate control signal GS from the source driver 14, and sequentially supply the gate signals Vg1 to Vgn to the gate lines GL1 to GLn based on a clock timing included in the gate control signal GS. By the supply of the gate signals Vg1 to Vgn, the pixel portions P₁₁ to Pₙₘ are selected for each pixel row. By applying the gradation voltage signals Vd1 to Vdm from the source driver 14 to the selected pixel portions, the gradation voltage is written to the pixel electrode.

In other words, by an operation of the gate drivers 13A and 13B, the m pixel portions arranged along (that is, in a row) an extension direction of a gate line are selected as a target to which the gradation voltage signals Vd1 to Vdm are supplied. The source driver 14 applies the gradation voltage signals Vd1 to Vdm to the selected pixel portions in a row, and causes a color corresponding to the voltage to be displayed. By selectively switching between the pixel portions in a row selected as the target to which the gradation voltage signals Vd1 to Vdm are supplied and repeating them in an extension direction (that is, vertical direction) of a source line, screen display corresponding to one frame is performed.

The source driver 14 is supplied with the video data signal VDS from the timing controller 12, generate the gradation voltage signals Vd1 to Vdm corresponding to a multilevel gradation voltage according to the number of gradations indicated in the video data signal VDS, and applies the gradation voltage signals Vd1 to Vdm to the pixel portions P₁₁ to Pₙₘ via the source lines SL1 to SLm.

Based on the frame synchronization signal FS, the source driver 14 generates the gate control signal GS that controls an operation timing of the gate drivers 13A and 13B and supplies the same to the gate drivers 13A and 13B.

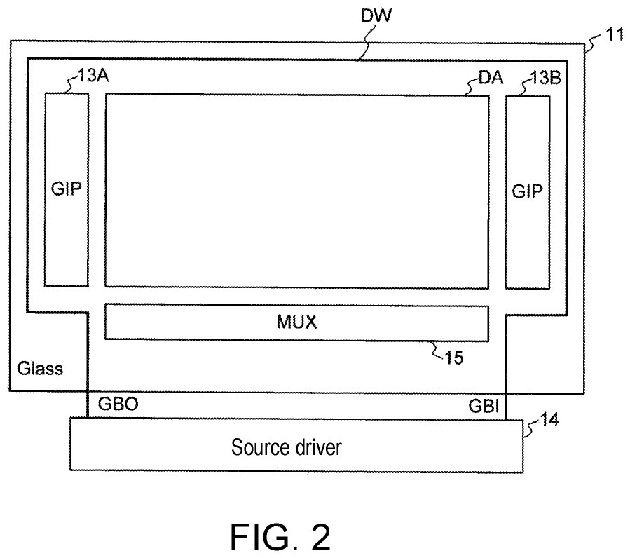

FIG. 2 is a block diagram illustrating a schematic configuration of the display panel 11, the source driver 14, and dummy wiring DW of the present example.

On the glass substrate (Glass) constituting the display panel 11, the gate drivers 13A and 13B mounted using GIP technology and a multiplex selector (indicated as “MUX” in FIG. 2) 15 are provided. The source driver 14 is formed on a substrate (second substrate) different from the glass substrate (first substrate) constituting the display panel 11.

The gate drivers 13A and 13B and the multiplex selector 15 are arranged so as to surround a display area DA of the display panel 11. The display area DA is provided in a central portion of the glass substrate, in which display wiring (not illustrated in FIG. 2) is formed including the source lines SL1 to SLm and the gate lines GL1 to GLn.

In the display panel 11, the dummy wiring DW is formed in an area outside the display area DA. In the present example, the dummy wiring DW is provided so as to surround an outer periphery of the display area DA, the gate drivers 13A and 13B, and the multiplex selector 15. The dummy wiring DW is made of, for example, a copper wire. The dummy wiring DW is connected to the source driver 14 via a first end GBO and a second end GBI.

The dummy wiring DW is detection wiring for detecting a crack occurring in the glass substrate constituting the display panel 11. The source driver 14 has a pair of connection terminals (that is, a first terminal and a second terminal), and is connected to the dummy wiring DW via the connection terminals. The source driver 14 determines whether disconnection has occurred in the dummy wiring DW based on a voltage at both ends of the dummy wiring DW. If it is determined that disconnection has occurred, the source driver 14 determines that a crack has occurred in the glass substrate.

The multiplex selector 15 is a selector that is provided between the display area DA of the display panel 11 and the source driver 14 and switchably supplies a gradation voltage signal output from the source driver 14 to a plurality of data lines. For example, based on a MUX control signal supplied from the source driver 14, the multiple selector 15 time-divisionally switches a data line to which the gradation voltage signal is supplied among the data lines corresponding to each of three RGB pixels. Accordingly, data lines D₁ to Dₙ are time-divisionally driven.

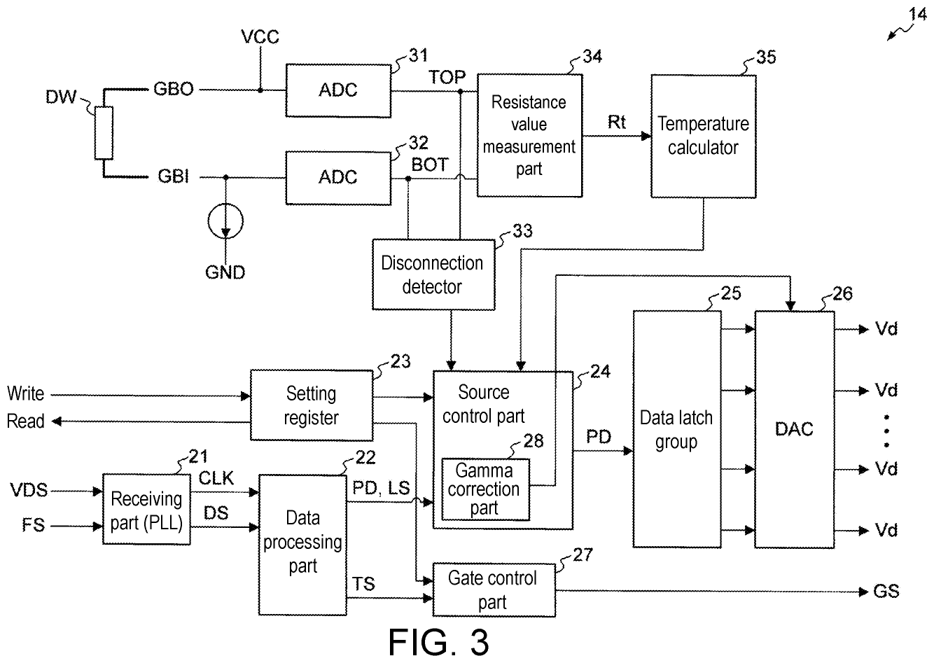

FIG. 3 is a block diagram illustrating an internal configuration of the source driver 14. The source driver 14 includes a receiving part (PLL) 21, a data processing part 22, a setting register 23, a source control part 24, a data latch group 25, a DA converter 26 (DAC 26), and a gate control part 27.

The receiving part 21 receives the video data signal VDS and the frame synchronization signal FS supplied from the timing controller 12. The receiving part 21 includes a phase locked loop (PLL) circuit, and generates the clock signal CLK based on the video data signal VDS and the frame synchronization signal FS. The receiving part 21 generates a serial data signal DS synchronized with the clock signal CLK, and supplies the same to the data processing part 22.

The data processing part 22 performs serial-parallel conversion on the data signal DS, generates parallel pixel data pieces PD and supplies the same to the source control part 24. The data processing part 22 generates a horizontal synchronization signal LS based on the data signal DS, and supplies the same to the source control part 24.

Based on the clock signal CLK, the data processing part 22 generates a timing control signal TS used in controlling the gate drivers 13A and 13B, and supplies the same to the gate control part 27.

The setting register 23 is a register circuit that stores setting data regarding an operation of the source driver 14. The setting data is written to the setting register 23 in response to a write operation from the timing controller 12. In response to a read operation by the timing controller 12, various data stored in the setting register 23 are read to the timing controller 12.

The source control part 24 reads the setting data stored in the setting register 23, and controls an operation of the data latch group 25 based on the read setting data. For example, the source control part 24 supplies to the data latch group 25 the parallel pixel data pieces PD supplied from the data processing part 22, and sequentially stores the pixel data pieces PD in each of data latches constituting the data latch group 25 using the horizontal synchronization signal LS as a capture clock.

The data latch group 25 and the DA converter 26 are a gradation voltage output part that outputs a gradation voltage signal under the control of the source control part 24. The data latch group 25 is composed of a plurality of latch circuits that capture the pixel data pieces PD. The plurality of latch circuits include, for example, a first latch circuit that captures the pixel data pieces PD one row at a time, and a second latch circuit that captures the pixel data pieces PD stored in the first latch circuit according to a rising timing of the horizontal synchronization signal LS.

The DA converter 26 selects a gradation voltage corresponding to the pixel data piece PD output from the data latch group 25, performs digital-to-analog conversion, and generates an analog gradation voltage signal Vd. The generated analog gradation voltage signal Vd is amplified by an output amplifier (not illustrated in FIG. 2) and output to the source lines SL1 to SLm of the display panel 11.

Based on the timing control signal TS supplied from the data processing part 22, the gate control part 27 generates the gate control signal GS. The gate control signal GS is supplied to the gate drivers 13A and 13B.

The source control part 24 includes a gamma correction part 28. Based on a gamma correction curve, the gamma correction part 28 performs gamma correction on the gradation voltage to be subjected to the digital-to-analog conversion in the DA converter 26

The source driver 14 includes AD converters (ADC) 31 and 32, a disconnection detector 33, a resistance value measurement part 34, and a temperature calculator 35.

The AD converter 31 is connected to the first end GBO of the dummy wiring DW. The AD converter 31 converts a potential of the first end GBO of the dummy wiring DW from analog to digital and generates a digital first voltage TOP. A connection line connecting the AD converter 31 and the first end GBO of the dummy wiring DW is connected to a power supply (power supply potential VCC).

The AD converter 32 is connected to the second end GBI of the dummy wiring DW. The AD converter 32 converts a potential of the second end GBI of the dummy wiring DW from analog to digital and generates a digital second voltage BOT. A connection line connecting the AD converter 32 and the second end GBI of the dummy wiring DW is grounded (connected to a ground potential GND).

Based on the voltage at both ends of the dummy wiring DW, the disconnection detector 33 detects the presence or absence of disconnection in the dummy wiring DW. Specifically, the disconnection detector 33 calculates a potential difference between the first voltage TOP and the second voltage BOT, which are output voltages of the AD converters 31 and 32, and compares the potential difference with a potential difference between the power supply potential VCC and the ground potential GND. As a result of the comparison, if the potential difference between the first voltage TOP and the second voltage BOT is almost equal to the potential difference between the power supply potential VCC and the ground potential GND (that is, if TOP−BOT [symbol] VCC−GND), the disconnection detector 33 determines (detects) that disconnection has occurred in the dummy wiring DW. The disconnection detector 33 supplies a detection result to the source control part 24.

Based on a voltage difference between the first voltage TOP and the second voltage BOT, that is, a potential difference between the first end GBO and the second end GBI of the dummy wiring DW, the resistance value measurement part 34 measures a resistance value of the dummy wiring DW at the current temperature. The resistance value measurement part 34 supplies a resistance value Rt which is a measurement result to the temperature calculator 35.

Based on the resistance value Rt of the dummy wiring DW measured by the resistance value measurement part 34, the temperature calculator 35 calculates the current temperature of the dummy wiring DW. The current temperature of the glass substrate constituting the display panel 11 is calculated. Specifically, based on the resistance value Rt which is the measurement result of the resistance value measurement part 34, a temperature coefficient X of copper (a substance forming the dummy wiring DW) and a resistance value Rref of the dummy wiring DW at a reference temperature Tref, the temperature calculator 35 calculates a current temperature Tt. The temperature Tt is expressed by the following Equation 1.

$$Tt = ( R t - Rref ) / X + Tref \qquad [ Equation 1 ]$$

The temperature calculator 35 supplies a calculated value of the temperature Tt to the source control part 24. The gamma correction part 28 of the source control part 24 adjusts the gamma correction curve based on the current temperature Tt supplied from the temperature calculator 35, and performs gamma correction on a gradation voltage using the adjusted gamma correction curve. For example, based on the temperature Tt, the gamma correction part 28 selects one gamma correction curve from among a plurality of types of gamma correction curves, and performs gamma correction on the gradation voltage based on the selected gamma correction curve.

Accordingly, gamma correction is performed according to the temperature of the display panel 11, and the gradation voltage signals Vd1 to Vdm reflecting the gamma correction are output from the source driver 14 and supplied to the pixel portions P₁₁ to Pₙₘ.

As described above, in the display device 100 of the present example, the temperature calculator 35 calculates the temperature based on the resistance value of the dummy wiring DW; the gamma correction part 28 adjusts the gamma correction curve based on the calculated temperature and performs gamma correction on the gradation voltage.

Since the dummy wiring DW is provided on the glass substrate constituting the display panel 11 and is in close contact with the display panel 11, the calculated temperature can be regarded as the current temperature of the display panel 11. Accordingly, unlike the case of, for example, performing gamma correction based on a temperature of a source driver located away from the display panel 11, gamma correction can be accurately performed based on a relatively accurate temperature.

In contrast to the case where it is necessary to provide a temperature sensor in the display panel 11 to measure the temperature of the display panel 11 itself, in the display device 100 of the present example, since the temperature is calculated using the dummy wiring DW provided for crack detection, there is no need to mount such a temperature sensor on the display panel 11. Accordingly, according to the display device 100 of the present example, appropriate gamma correction according to the temperature can be performed while an increase in the number of parts is suppressed.

As described above, according to the display device 100 of the present example, it is possible to accurately perform gamma correction according to the temperature without increasing the number of parts of the liquid crystal panel.

### Example 2

Next, Example 2 of the disclosure will be described. A display device 200 of the present example differs from the display device 100 of Example 1 in that a source driver is composed of two driver ICs each responsible for supplying the gradation voltage signals Vd1 to Vdm to the pixel portions P₁₁ to Pₙₘ.

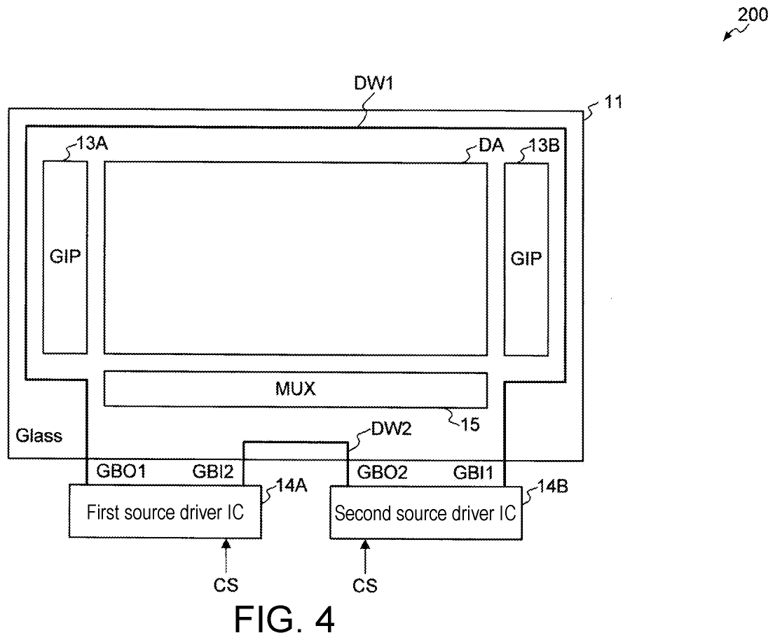

FIG. 4 is a block diagram illustrating a schematic configuration of the display panel 11, a first source driver IC 14A, a second source driver IC 14B, and dummy wiring DW1 and dummy wiring DW2 of Example 2.

Similarly to Example 1, on the glass substrate (Glass) constituting the display panel 11, the dummy wiring DW1 is provided so as to surround the outer periphery of the display area DA, the gate drivers 13A and 13B, and the multiplex selector 15. The dummy wiring DW1 is made of, for example, a copper wire, and is connected to the first source driver IC 14A and the second source driver IC 14B via a first end GBO1 and a second end GBI1.

In the present example, the dummy wiring DW2 is provided in addition to the dummy wiring DW1. Similarly to the dummy wiring DW1, the dummy wiring DW2 is made of a copper wire. The dummy wiring DW2 is connected to the first source driver IC 14A via a first end GBI2, and is connected to the second source driver IC 14B via a second end GBO2.

The first source driver IC 14A and the second source driver IC 14B are composed of different driver ICs having similar functions. A setting communication signal CS for controlling writing and reading to and from a register, which will be described later, is supplied from the timing controller 12 to each of the first source driver IC 14A and the second source driver IC 14B.

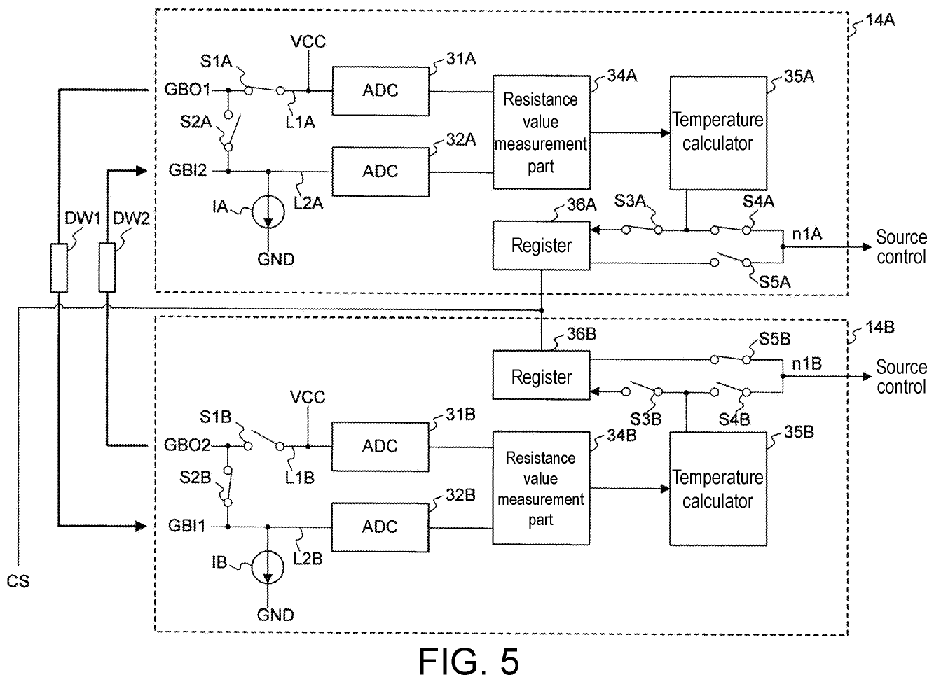

FIG. 5 is a block diagram illustrating an internal configuration of the first source driver IC 14A and the second source driver IC 14B. Here, illustration and description of blocks (receiving part, data processing part, setting register, source control part, data latch group, DA converter, and gate control part) related to output processing of the normal gradation voltage signals Vd1 to Vdm are omitted.

The first source driver IC 14A includes AD converters (ADC) 31A and 32A, a resistance value measurement part 34A, a temperature calculator 35A, and a register 36A. Similarly to the source driver 14 of Example 1, the first source driver IC 14A includes a disconnection detector (whose illustration is omitted in FIG. 5).

The AD converter 31A is configured to be connectable to the first end GBO1 of the dummy wiring DW1 via a switch S1A. That is, the AD converter 31A is connected to the first end GBO1 of the dummy wiring DW1 when the switch S1A is on, and is disconnected from the first end GBO1 of the dummy wiring DW1 when the switch S1A is off.

The AD converter 32A is connected to the first end GBI2 of the dummy wiring DW2. Between a line L1A that connects the first end GBO1 of the dummy wiring DW1 and the AD converter 31A and a line L2A that connects the first end GBI2 of the dummy wiring DW2 and the AD converter 32A, a short circuit can be caused via a switch S2A. That is, the line L1A is connected (short-circuited) to the line L2A when the switch S2A is on, and is disconnected from the line L2A when the switch S2A is off.

The line L2A is connected to the ground potential via a constant current source IA. The constant current source IA is controlled to be turned on and off in conjunction with the switch S2A. Specifically, when the switch S2A is on, the constant current source IA is turned off; when the switch S2A is off, the constant current source IA is turned on.

The switch S1A and the switch S2A are controlled to be turned on and off in a complementary manner according to, for example, a switching signal supplied from the timing controller 12 to the first source driver IC 14A. When the switch S1A is on and the switch S2A is off, the first end GBO1 of the dummy wiring DW1 and the AD converter 31A are connected to each other, the first end GBI2 of the dummy wiring DW2 and the AD converter 32A are connected to each other, a resistance value is measured by the resistance value measurement part 34A, and a temperature is calculated by the temperature calculator 35A. On the other hand, when the switch S1A is off and the switch S2A is on, the first end GBO1 of the dummy wiring DW1 and the first end GBI2 of the dummy wiring DW2 are short-circuited, and measurement of the resistance value by the resistance value measurement part 34A and calculation of the temperature by the temperature calculator 35A are not performed.

The register 36A is a storage part that stores a result of temperature calculation by the temperature calculator 35A. The register 36A is configured to be connectable to the temperature calculator 35A via a switch S3A. The register 36A is configured to be able to write and read data (that is, the result of temperature calculation) based on the setting communication signal CS from the timing controller 12.

The temperature calculator 35A is configured to be connectable to an output node n1A for outputting the result of temperature calculation to the source control part via a switch S4A. The register 36A is configured to be connectable to the output node n1A via a switch S5A.

The switches S3A and S4A are controlled to be turned on and off in a complementary manner with respect to the switch S5A according to, for example, the switching signal from the timing controller 12. When the switches S3A and S4A are on and the switch S5A is off, the result of temperature calculation by the temperature calculator 35A is supplied to the source control part via the output node n1A, and is stored in the register 36A. On the other hand, when the switches S3A and S4A are off and the switch S5A is on, the result of temperature calculation stored in the register 36A is read and supplied to the source control part.

The second source driver IC 14B includes AD converters (ADC) 31B and 32B, a resistance value measurement part 34B, a temperature calculator 35B, and a register 36B. Similarly to the source driver 14 of Example 1, the second source driver IC 14B includes a disconnection detector (whose illustration is omitted in FIG. 5).

The AD converter 31B is configured to be connectable to the second end GBO2 of the dummy wiring DW2 via a switch S1B. That is, the AD converter 31B is connected to the second end GBO2 of the dummy wiring DW2 when the switch S1B is on, and is disconnected from the second end GBO2 of the dummy wiring DW2 when the switch S1B is off.

The AD converter 32B is connected to the second end GBI1 of the dummy wiring DW1. Between a line L1B that connects the second end GBO2 of the dummy wiring DW2 and the AD converter 31B and a line L2B that connects the second end GBI1 of the dummy wiring DW1 and the AD converter 32B, a short circuit can be caused via a switch S2B. That is, the line LIB is connected (short-circuited) to the line L2B when the switch S2B is on, and is disconnected from the line L2B when the switch S2B is off.

The line L2B is connected to the ground potential via a constant current source IB. The constant current source IB is controlled to be turned on and off in conjunction with the switch S2B. Specifically, when the switch S2B is on, the constant current source IB is turned off; when the switch S2B is off, the constant current source IB is turned on.

The switch SIB and the switch S2B are controlled to be turned on and off in a complementary manner according to, for example, a switching signal supplied from the timing controller 12 to the second source driver IC 14B. When the switch S1B is on and the switch S2B is off, the second end GBO2 of the dummy wiring DW2 and the AD converter 31B are connected to each other, the second end GBI1 of the dummy wiring DW1 and the AD converter 32B are connected to each other, a resistance value is measured by the resistance value measurement part 34B, and a temperature is calculated by the temperature calculator 35B. On the other hand, when the switch S1B is off and the switch S2B is on, the second end GBO2 of the dummy wiring DW2 and the second end GBI1 of the dummy wiring DW1 are short-circuited, and measurement of the resistance value by the resistance value measurement part 34B and calculation of the temperature by the temperature calculator 35B are not performed.

The register 36B is a storage part that stores a result of temperature calculation by the temperature calculator 35B. The register 36B is configured to be connectable to the temperature calculator 35B via a switch S3B. The register 36B is configured to be able to write and read data (that is, the result of temperature calculation) based on the setting communication signal CS from the timing controller 12.

The register 36A of the first source driver IC 14A and the register 36B of the second source driver IC 14B are connected to each other. The register 36A and the register 36B are configured so that data stored in one of them can be read and stored in the other based on the setting communication signal CS from the timing controller 12.

The temperature calculator 35B is configured to be connectable to an output node n1B for outputting the result of temperature calculation to the source control part via a switch S4B. The register 36B is configured to be connectable to the output node n1B via a switch S5B.

The switches S3B and S4B are controlled to be turned on and off in a complementary manner with respect to the switch S5B according to, for example, the switching signal from the timing controller 12. When the switches S3B and S4B are on and the switch S5B is off, the result of temperature calculation by the temperature calculator 35B is supplied to the source control part via the output node n1B, and is stored in the register 36B. On the other hand, when the switches S3B and S4B are off and the switch S5B is on, the result of temperature calculation stored in the register 36B is read and supplied to the source control part.

In the display device 200 of the present example, on and off of each switch are controlled so that only one of the temperature calculator 35A of the first source driver IC 14A and the temperature calculator 35B of the second source driver IC 14B performs temperature calculation.

For example, in a first mode, the switches S1A, S3A, S4A, S2B, and S5B are on, and the switches S2A, S5A, S1B, S3B, and S4B are off. Accordingly, the temperature is calculated by the temperature calculator 35A of the first source driver IC 14A, the calculation result is supplied to the source control part of the first source driver IC 14A and is stored in the register 36A. The calculation result read from the register 36A is supplied to and stored in the register 36B of the second source driver IC 14B. The calculation result read from the register 36B is supplied to and stored in the source control part of the second source driver IC 14B.

In the first source driver IC 14A, gamma correction on a gradation voltage is performed based on the temperature calculated by the temperature calculator 35A. In the second source driver IC 14B, gamma correction on a gradation voltage is performed based on the calculation result of the temperature supplied from the first source driver IC 14A.

On the other hand, in a second mode, the switches S1A, S3A, S4A, S2B, and S5B are off, and the switches S2A, S5A, S1B, S3B, and S4B are on. Accordingly, the temperature is calculated by the temperature calculator 35B of the second source driver IC 14B, the calculation result is supplied to the source control part of the second source driver IC 14B and is stored in the register 36B. The calculation result read from the register 36B is supplied to and stored in the register 36A of the first source driver IC 14A. The calculation result read from the register 36A is supplied to and stored in the source control part of the first source driver IC 14A.

In the second source driver IC 14B, gamma correction on a gradation voltage is performed based on the temperature calculated by the temperature calculator 35B. In the first source driver IC 14A, gamma correction on a gradation voltage is performed based on the calculation result of the temperature supplied from the second source driver IC 14B.

As described above, in the display device 200 of the present example, the source driver is composed of two driver ICs, namely, the first source driver IC 14A and the second source driver IC 14B. Each of the first source driver IC 14A and the second source driver IC 14B is configured to be able to calculate the current temperature based on a resistance value at an end of the dummy wiring DW1 and the dummy wiring DW2. Each driver IC is configured so that a temperature calculation result can be stored in a register, the temperature calculation result stored in the register of one of the driver ICs can be supplied to the other driver IC, and gamma correction can be performed using the temperature calculation result.

According to such a configuration, in a display device in which the source driver is composed of a plurality of driver ICs, it is possible to efficiently perform gamma correction according to the temperature.

### Example 3

Next, Example 3 of the disclosure will be described. A display device 300 of the present example differs from the display device 100 of Example 1 in that a temperature is calculated using wiring (hereinafter referred to as MUX wiring) for controlling the multiplex selector 15, instead of dummy wiring.

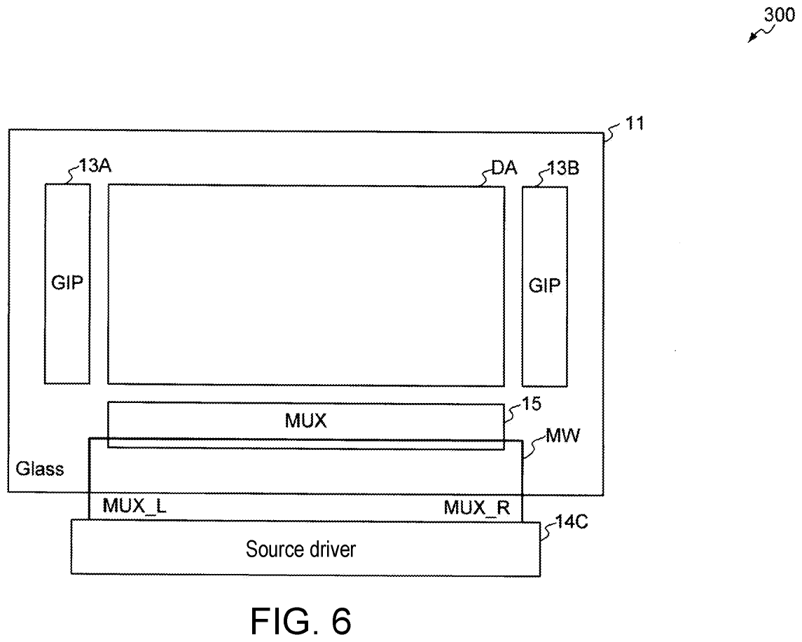

FIG. 6 is a block diagram illustrating a schematic configuration of the display panel 11, a source driver 14C, and MUX wiring MW of Example 3.

On the glass substrate (Glass) constituting the display panel 11, the MUX wiring MW is provided which is wiring for controlling an operation of the multiplex selector (indicated as “MUX” in FIG. 6) 15. The MUX wiring MW is connected to the source driver 14C via a left side end MUX_L and a right side end MUX_R. The source driver 14C has a pair of connection terminals, and is connected to the left side end MUX_L and the right side end MUX_R of the MUX wiring MW via the connection terminals.

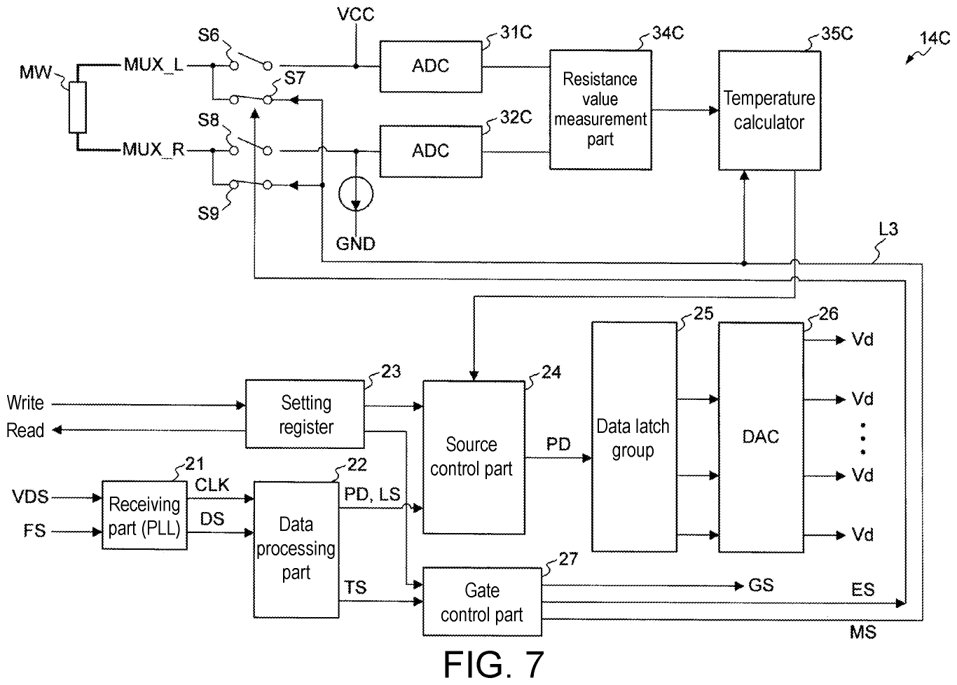

FIG. 7 is a block diagram illustrating an internal configuration of the source driver 14C of the present example. Similarly to the source driver 14 of Example 1, the source driver 14C includes the receiving part (PLL) 21, the data processing part 22, the setting register 23, the source control part 24, the data latch group 25, the DA converter 26 (DAC 26), and the gate control part 27.

The source driver 14C includes AD converters (ADC) 31C and 32C, a resistance value measurement part 34C, and a temperature calculator 35C.

The AD converter 31C is configured to be connectable to the left side end MUX_L of the MUX wiring MW via a switch S6. That is, the AD converter 31C is connected to the left side end MUX_L of the MUX wiring MW when the switch S6 is on, and is disconnected from the left side end MUX_L of the MUX wiring MW when the switch S6 is off.

The left side end MUX_L of the MUX wiring MW is configured to be connectable to, via a switch S7, a line L3 which is a supply line of a MUX control signal MS from the gate control part 27. That is, the line L3 is connected to the left side end MUX_L of the MUX wiring MW when the switch S7 is on, and is disconnected from the left side end MUX_L of the MUX wiring MW when the switch S7 is off.

The AD converter 32C is configured to be connectable to the right side end MUX_R of the MUX wiring MW via a switch S8. That is, the AD converter 32C is connected to the right side end MUX_R of the MUX wiring MW when the switch S8 is on, and is disconnected from the right side end MUX_R of the MUX wiring MW when the switch S8 is off.

The right side end MUX_R of the MUX wiring MW is configured to be connectable to, via a switch S9, the line L3 which is the supply line of the MUX control signal MS from the gate control part 27. That is, the line L3 is connected to the right side end MUX_R of the MUX wiring MW when the switch S9 is on, and is disconnected from the right side end MUX_R of the MUX wiring MW when the switch S9 is off.

The switch S6 and the switch S8 are controlled to be turned on and off at the same timing based on an enable control signal ES from the gate control part 27. The switch S7 and the switch S9 are controlled to be turned on and off at the same timing based on the enable control signal ES from the gate control part 27.

The switches S6 and S8 are controlled to be turned on and off in a complementary manner with respect to the switches S7 and S9 according to the enable control signal ES from the gate control part 27. For example, when a signal level of the enable control signal ES is H level (logical level 1), the switches S6 and S8 are turned on, and the switches S7 and S9 are turned off. When the signal level of the enable control signal ES is L level (logical level 0), the switches S6 and S8 are turned off, and the switches S7 and S9 are turned on.

When the switches S6 and S8 are on and the switches S7 and S9 are off, the left side end MUX_L of the MUX wiring MW is connected to the AD converter 31C, and the right side end MUX_R of the MUX wiring MW is connected to the AD converter 32C. The resistance value measurement part 34C measures a resistance value based on a potential difference of the MUX wiring MW. The temperature calculator 35C calculates the current temperature based on the resistance value measured by the resistance value measurement part 34C.

On the other hand, when the switches S6 and S8 are off and the switches S7 and S9 are on, the left side end MUX_L of the MUX wiring MW and the right side end MUX_R of the MUX wiring MW are connected to the line L3 which is the supply line of the MUX control signal MS. Accordingly, the MUX control signal MS is supplied to the MUX wiring MW, and an operation of the multiplex selector 15 is controlled.

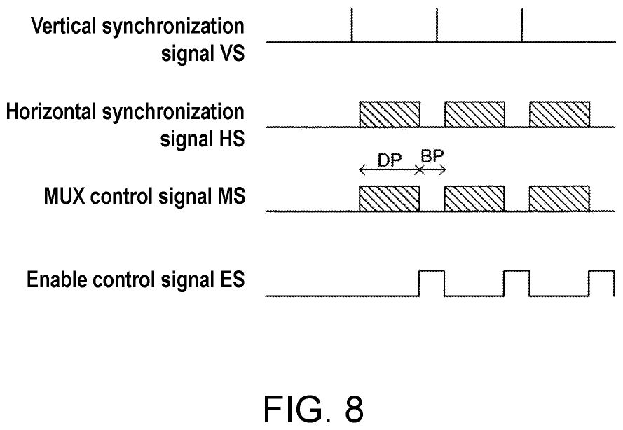

FIG. 8 is a time chart illustrating a signal change in the enable control signal ES for switching on and off of the switches S6 to S9.

During a display period DP during which the display panel 11 performs display for each horizontal scanning line, normal display control is performed. The gate control part 27 outputs the enable control signal ES of L level (logical level 0) in the display period DP. Accordingly, the MUX control signal MS is supplied to the MUX wiring MW, the gradation voltage signals Vd1 to Vdm are applied from the source driver 14C to the pixel portions P₁₁ to Pₙₘ via the source lines SL1 to SLm, and display is performed.

On the other hand, normal display control is not performed during a blank period BP which is a period between the display periods DP for each horizontal scanning line. The gate control part 27 outputs the enable control signal ES of H level (logical level 1) in the blank period BP as a temperature measurement period. Accordingly, the MUX wiring MW is connected to the resistance value measurement part 34C, the resistance value is measured, and the temperature is calculated by the temperature calculator 35C.

As described above, in the display device 300 of the present example, by using the blank period BP provided between the display periods DP for each horizontal scanning line, the temperature is calculated using the MUX wiring MW.

According to such a configuration, even if wiring that is not directly related to a display operation, like the dummy wiring DW illustrated in Example 1, is not provided, it is possible to calculate the temperature of the display panel 11 and accurately perform gamma correction according to the temperature.

The disclosure is not limited to the above embodiments. In Example 1, a case where the dummy wiring DW is made of copper has been described as an example. However, the material of the dummy wiring DW is not limited to copper. By the resistance value measurement part 34 and the temperature calculator 35 measuring the resistance value and calculating the temperature according to the material of the dummy wiring DW, it is possible to accurately perform gamma correction according to the temperature.

In Example 2, a configuration has been described as an example where the first source driver IC 14A and the second source driver IC 14B each having a temperature calculation function are provided and the temperature measured by one of the driver ICs is used for gamma correction by the other driver IC. However, it is not necessary that both driver ICs have the temperature calculation function, and it is sufficient that at least one of the driver ICs has the temperature calculation function. The number of driver ICs that constitute a source driver is not limited to two, and may be three or more.

The configurations of each example above can be used in combination as appropriate. For example, in a configuration in which Example 2 and Example 3 are combined and the first source driver IC 14A and the second source driver IC 14B are provided, the temperature may be calculated using the MUX wiring MW.

What is claimed is:

1. A display device, comprising:
a display panel, comprising a first substrate having a display area, display wiring comprising a plurality of source lines and a plurality of gate lines formed in the display area, and first wiring formed in an area outside the display area of the first substrate; and
a source driver, provided outside the first substrate, comprising a temperature calculator that calculates a temperature of the first substrate based on a potential difference between one end and an other end of the first wiring, the source driver driving the plurality of source lines.

2. The display device according to claim 1, wherein
the source driver further comprises a resistance value measurement part that measures a resistance value of the first wiring based on the potential difference between the one end and the other end of the first wiring; and
the temperature calculator performs an operation of calculating a current temperature of the first wiring based on the resistance value of the first wiring measured by the resistance value measurement part, and calculates the current temperature of the first wiring being a result of the operation as the temperature of the first substrate.

3. The display device according to claim 1, wherein
the first wiring is detection wiring for crack detection arranged to surround the display area on the first substrate; and
the source driver further comprises a crack detection circuit that detects occurrence of a crack in the first substrate based on a potential difference between the one end and the other end of the detection wiring.

4. The display device according to claim 1, further comprising:
a multiplex selector, switchably supplying a gradation voltage signal output from the source driver to each of the plurality of source lines according to each RGB pixel, wherein
the first wiring is a signal supply line for supplying the multiplex selector with a switching control signal that controls a switching operation of the multiplex selector; and
the temperature calculator calculates the temperature during a blank period provided between display periods during which the display panel performs display for each horizontal scanning line.

5. The display device according to claim 1, wherein
the source driver further comprises a first driver IC connected to the one end of the first wiring and a second driver IC connected to the other end of the first wiring;
each of the first driver IC and the second driver IC comprises the temperature calculator, a register that stores a calculation result of the temperature calculator, a gradation voltage output part that outputs a gradation voltage signal to the plurality of source lines, and a gamma correction part that performs gamma correction on the gradation voltage signal based on the calculation result of the temperature calculator; and
in response to the temperature calculator calculating the temperature in one of the first driver IC and the second driver IC, the gamma correction part of an other of the first driver IC and the second driver IC performs gamma correction on the gradation voltage signal based on a calculation result of the temperature in the one of the first driver IC and the second driver IC.

6. The display device according to claim 1, wherein
the source driver further comprises a gradation voltage output part that outputs a gradation voltage signal to the plurality of source lines and a gamma correction part that performs gamma correction on the gradation voltage signal; and
the gamma correction part performs the gamma correction based on the temperature of the first substrate calculated by the temperature calculator.

7. A source driver, removably connected to a display panel that comprises a first substrate, a plurality of source lines and first wiring, the first substrate having a display area, the plurality of source lines being formed in the display area, the first wiring being formed in an area outside the display area of the first substrate, wherein the source driver drives the plurality of source lines and comprises:
a first terminal, connected to one end of the first wiring;
a second terminal, connected to the other end of the first wiring; and
a temperature calculator, calculating a temperature of the first substrate based on a potential difference between the one end and the other end of the first wiring.
